(19) United States
(12) Patent Application Publication
(10) Pub. No.: US 2019/0287089 A1
(43) Pub. Date: Sep. 19, 2019

(54) BEVERAGE KIOSK APPARATUS, SYSTEM, AND METHOD

(71) Applicant: Instream Water, Inc., Colorado Springs, CO (US)

(72) Inventor: Patrick Mahncke, Colorado Springs, CO (US)

(73) Assignee: Instream Water, Inc., Colorado Springs, CO (US)

(21) Appl. No.: 16/428,484

(22) Filed: May 31, 2019

Related U.S. Application Data
(63) Continuation-in-part of application No. 16/030,666, filed on Jul. 9, 2018.
(60) Provisional application No. 62/529,948, filed on Jul. 7, 2017.

(51) Int. Cl. G06Q 20/20; G06K 7/10

(52) U.S. Cl. CPC G06Q 20/204; G06K 7/10366

(57) ABSTRACT

Certain embodiments of the invention include a system, method, and apparatus surrounding the delivery of a filtered beverage. Certain embodiments include a filtered beverage kiosk that provides filtered and disinfected beverage. The filtered beverage kiosk includes hardware components and associated software connected to a network, where the software and hardware is controllable through the network. Certain embodiments include an RFID-tag associated with a bottle or a band, and an RFID reader and writer that accounts for the dispensing of the beverage into a receptacle. Users are able to add funds to the RFID tag, while the RFID reader and writer debits the RFID tag to account for the dispensed beverage.

### CROSS REFERENCE TO REFERENCE TO RELATED APPLICATIONS

This application is a Continuation in Part of copending U.S. patent application Ser. No. 16/030,666 entitled, “BEVERAGE KIOSK APPARATUS, SYSTEM, AND METHOD” filed on Jul. 9, 2018, which claims the benefit of U.S. Provisional Patent Application 62/529,948 entitled “BEVERAGE KIOSK APPARATUS, SYSTEM, AND METHOD” filed on Jul. 7, 2017; the entire contents of which are incorporated herein by reference in its entirety for all purposes.

### FIELD OF THE INVENTION

Embodiments of the present invention generally relate to a system, method, and apparatus for fluid-dispensing kiosks.

### BACKGROUND OF THE INVENTION

Single-use plastic bottles are used to transport and sell a variety of beverages. Single-use plastic bottles are wasteful, and create a negative impact on the environment. The negative environmental impact of manufacturing, delivering, and disposing plastic bottles include: the use of hydrocarbons used to create the bottles, the energy needed for manufacture, the carbon emissions related to shipping and distribution, as well as the waste created during disposal. Although plastic bottles are commonly designed to be recycled, not all bottles are recycled and thus end up in landfills or are littered. For instance, U.S. post-consumer plastic waste for 2008 was estimated at 33.6 million tons. Of the total plastic waste, only 6.5% was recycled, 7.7% was burned for energy, and 85.5% -28.9 million tons were discarded in landfills.

Furthermore, the negative environmental impacts of plastic bottles extend to the servicing of vending machines necessary for the distribution of beverages contained in plastic bottles.

Although the use of plastic bottles is often tied to factors of convenience, the use of plastic bottles in some cases is tied to the need for clean drinking water. Aging water infrastructure in certain municipalities requires updating in order to meet Environmental Protection Agency (EPA) requirements and to provide drinking water within acceptable chemical and mineral contents. Many of the contaminants can be found or is generated towards the dispensing end of a water infrastructure rather than at central locations. Thus, updating water infrastructure is often expensive, time consuming, and in some cases not feasible. As such, plastic bottles offer an intermediate solution for offering clean drinking water to residents in these municipalities.

Therefore, there is an overall need to reduce the number of plastic bottles used and consumed. There is also a need to provide a safer, and better tasting alternative to tap water to more locations, while reducing costs. There is a need for a cost-effective alternative to updating water utilities. There is a particular need to provide filtered, clean water that meets certain EPA requirements at the point of dispensing. There is also a particular need to reduce the cost of providing filtered water by passing along the savings generated from eliminating the manufacturing, distribution, and packaging of traditional plastic bottles. There is also a need to more efficiently pay, and receive payment for water by reducing the use of cash or coins.

### SUMMARY OF THE INVENTION

It is an object of certain embodiments of the invention that the design, manufacture, and installation of certain embodiments of the system, method, and apparatus described herein provide a consumer or user a convenient, environmentally friendly, and economical alternative to single-use plastic bottles. It is also the object of certain embodiments of the invention to reduce the number of single-use plastic bottles manufactured, distributed, and disposed of each year, by offering a clean, consistent, and economical alternative. It is also the object of certain embodiments of the invention to provide a beverage kiosk that accepts electronic payment methods, in order to reduce carbon emissions related to servicing cash or coin operated beverage dispensing machines.

It is an object of certain embodiments of the invention to provide clean water in public spaces by offering a system that filters contaminants from the water supply to within acceptable levels, such as dictated by the EPA, at the point of dispensing. Certain embodiments of the invention are intended for installation in a number of areas, including universities, airports, municipalities, festivals, malls and other locations to utilize their existing plumbing infrastructure to run municipal water into a kiosk.

In certain embodiments, a filtered beverage kiosk includes filters and disinfecting components, for example, using a combination of carbon filters and ultraviolet (UV) systems. It is an object of certain embodiments of the invention to dispense a filtered beverage into a consumer's bottle for a small fee. In certain embodiments, a beverage is carbonated and/or chilled. It is an object of the invention for certain embodiments to include a cashless and coinless payment technology to facilitate the transaction.

Certain embodiments of the invention include a receptacle that will interact with the contactless payment hardware and software in the kiosk. Certain embodiments of a receptacle include a radio frequency identification (RFID) tag or chip. It will be appreciated that a number of RFID protocols may be used in embodiments of the invention described herein. An example of an RFID protocol used in certain embodiments is Near Field Communication (NFC). An RFID protocol, such as NFC, allows for an effortless payment solution. In certain embodiments, an RFID tag is located on a band or a sleeve configured to attach to existing reusable receptacles. In certain embodiments, the RFID tag stores user information, user preferences, and a stored value corresponding with a monetary amount.

In certain embodiments, a user monitors fluid dispensed through a kiosk, further syncing fluid consumption data with an app. The tracked data are further sent to an app such that the user can track their individual water consumption. In certain embodiments, a user manages the value stored on an RFID tag using an RFID reader and writer installed on the filling platform. In certain embodiments, an RFID reader and writer communicates with the RFID protocol. Using an RFID tag, such as those affixed to a receptacle, the user can pay for the beverage by placing the receptacle on the filling platform. An RFID reader and writer installed on the filling platform debits the consumer's stored value on the respective chip once the beverage is dispensed. In certain embodiments, an RFID reader and writer found on a mobile phone, or a peripheral reader and writer are used to read and write the data on the RFID tag or chip.

In certain embodiments, a beverage kiosk described herein includes software controlling the hardware components. The software controls the hardware components, allowing the kiosk to be managed and monitored remotely. In certain embodiments the remote manipulation of valves through the software allows, for example—flushing the system to clean the kiosk, dispensing the fluid, and shutting off the flow of fluid. In certain embodiments, data can be recorded and aggregated, such data including, but not limited to fluid consumption, temperature, and transaction data.

In certain embodiments, the kiosk provides real-time pricing adjustments. These price adjustments are made in response to business and environmental conditions, including, for example, location of a kiosk, the time of day, events, product dispensed, among other variables. Some existing technologies such as—U.S. Patent Publication No. 2011/0168775 to Van Zetten, filed Jan. 13, 2010; U.S. Patent Publication No. 2005/0087255 to Humphrey et al., filed Oct. 22, 2004; U.S. Patent Publication No. 2013/0085874 to Gagne et al., filed on Sep. 26, 2012; U.S. Patent Publication No. 2010/0125362 to Canora, et al., filed Nov. 20, 2008; U.S. Patent Publication No. 2012/0035761 to Tilton et al., filed Feb. 4, 2011—all of which are incorporated by reference herein for all purposes—use an RFID reader at a point of sale for the purposes of tracking customer purchasing activities. Such technologies are directed toward the use of a disposable paper-type beverage cup having an RFID chip affixed or adhered to it such that the RFID chip is disposed of along with the cup after use.

In some scenarios, a user may wish to use a certain reusable bottle or beverage container based on activity, capacity, or based on which container is currently clean. It is an aspect of the present invention to permit the interchangeability of beverage containers while allowing a user to use the same RFID tag. In certain embodiments, a sleeve or boot having an embedded RFID is configured to be slidably attached to the body of a beverage container such as a bottle.

Many reusable bottles comprise a metal body such as stainless steel or aluminum, and sometimes multiple layers of metal for insulative properties. It is appreciated to those skilled in the art that RFID and NFC technology does not work reliably when an RFID tag is on or near proximity to metal. NFC tags are made up of metallic and other components such that when they come into contact with another metal surface, electromagnetic interference is created when the tag comes in contact with a signal from an NFC tag reader. The interference created disrupts the capability of the tag and reader to communicate successfully and transfer data.

It is an aspect of certain embodiments to provide reliable communication between an RFID reader and an RFID tag when in near proximity to a steel-walled container or other container that may cause communication interferences.

In certain embodiments, a sleeve or boot has a ferrite layer disposed between the RFID tag and the beverage container. It will be appreciated that “ferrite” references ceramics consisting of various metal oxides formulated to have very high permeability. Iron, manganese, manganese zinc (MnZn), and nickel zinc (NiZn) are the most commonly used oxides in ferrite. Ferrite layers provides management of magnetic flux which may otherwise interfere with NFC or RFID communication protocols. In certain embodiments it is desirable to use a sintered ferrite layer which is designed for high-performance magnetic flux redirection and management to improve communications efficiency and range. Certain embodiments comprise a flexible ferrite layer comprising a sintered ferrite layer.

In certain embodiments, a boot comprises an elastomer, such as silicone which protects against damage in the in the event the beverage container is inadvertently dropped. A boot of certain embodiments also provides heat and moisture protection.

In certain embodiments, the RFID tag is embedded within a sidewall of a boot in a vertical orientation with a ferrite layer disposed between the RFID tag and the inner aspect of the boot. In certain embodiments the RFID tag is embedded within a flexible layer for embedding within the sidewall of the boot. In certain embodiments a ferrite layer is disposed between an RFID tag embedded into the sidewall of the boot and an inner aspect of the boot, such as an inner surface of the sidewall of the boot. In certain embodiments the RFID tag, which typically comprises an oblong shape, is mounted horizontally. In alternate embodiments, an RFID tag comprising an oblong shape is mounted vertically. By mounting the RFID vertically, it provides an increased height profile, thus increasing the chance of being read by a static RFID reader having a fixed height. A vent hole is disposed in the bottom of a boot of certain embodiments to allow the escape of air when attaching or removing the boot from a receptacle, thereby preventing a vacuum lock situation in which it is difficult to remove the boot.

In certain embodiments, an RFID tag is embedded within a band for removable fixation to the receptacle. Certain embodiments comprising a band, further comprise a ferrite layer disposed between the RFID tag and an internal aspect of the band.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1—A beverage kiosk in certain embodiments of the invention.

FIG. 2A—An embodiment of an RFID-enabled receptacle, where an RFID-tag is embedded in the receptacle.

FIG. 2B—An embodiment of RFID-enabled receptacle, where an RFID-tag is attached to the receptacle.

FIG. 2C—Embodiments of an RFID reader in certain embodiments of the invention.

FIG. 3—Diagram showing the interaction of the system in certain embodiments.

FIG. 4—A schematic diagram of the beverage kiosk in certain embodiments of the invention.

FIG. 5A—A rear perspective view of a beverage kiosk in certain embodiments.

FIG. 5B—A front perspective view of a beverage kiosk in certain embodiment.

FIG. 5C—A front perspective view of a beverage kiosk in an open configuration.

FIG. 6A—An exemplary flow chart of a user interacting with the beverage kiosk system.

FIG. 6B—An exemplary flow chart of a user interacting with the beverage kiosk system, continued from FIG. 6A.

FIG. 6C—An exemplary flow chart of a user interacting with the beverage kiosk system, continued from FIG. 6B.

FIG. 7A—An embodiment of the application executed on a computing device.

FIG. 7B—An embodiment of the application executed on a computing device.

FIG. 8A—A perspective view of a boot for the fixation of an RFID tag to a beverage receptacle.

FIG. 8B—A cross-sectional view of a boot for the fixation of an RFID tag to a beverage receptacle.

FIG. 8C—A perspective view of a band for the removable fixation of an RFID tag to a beverage receptacle.

### DETAILED DESCRIPTION

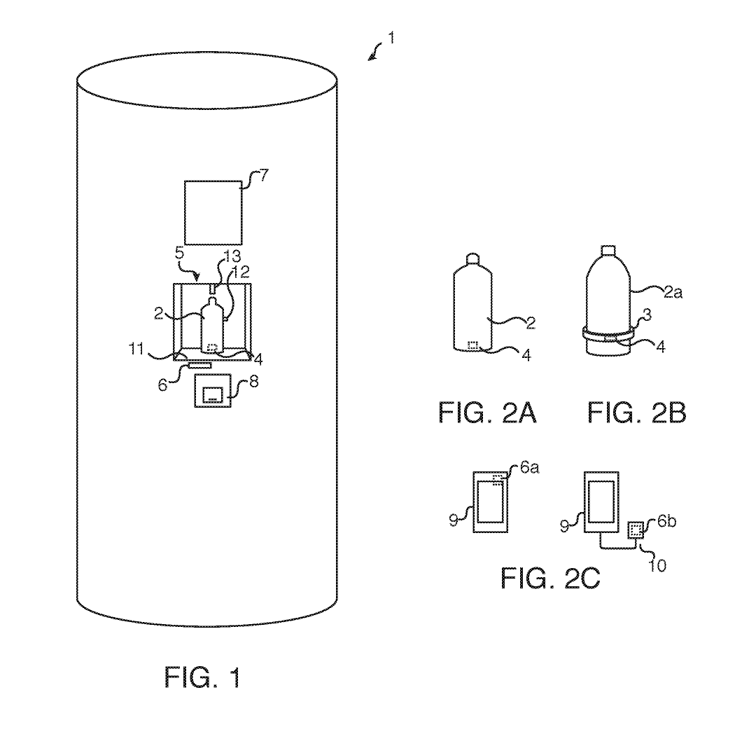

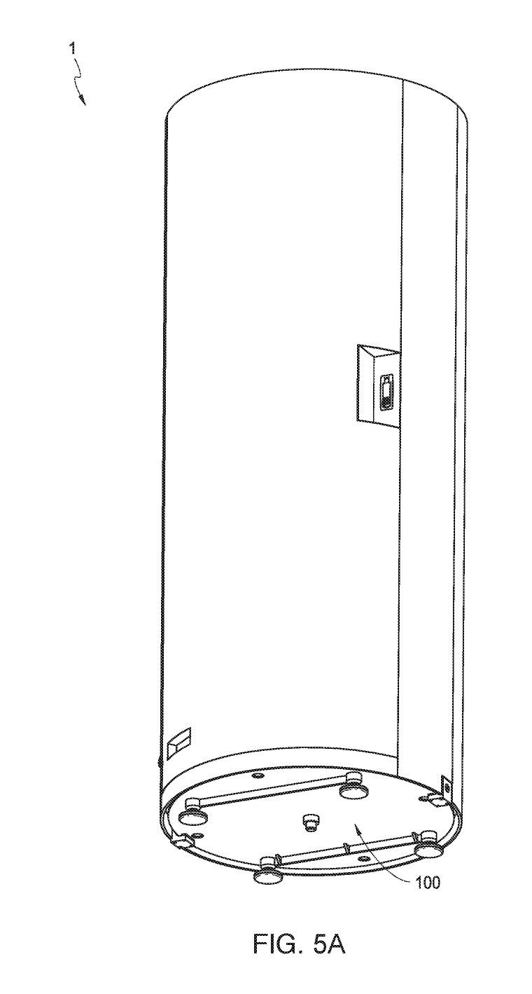

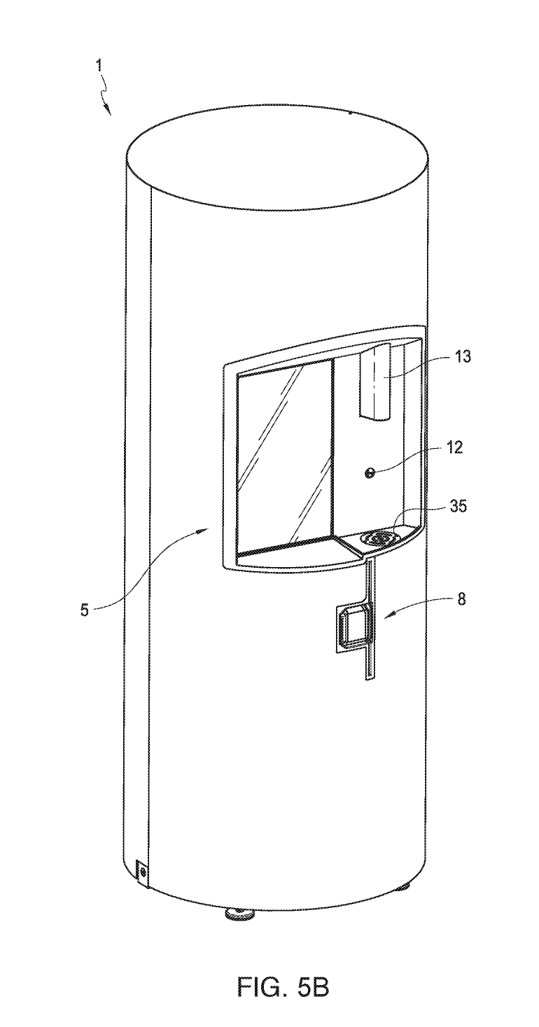

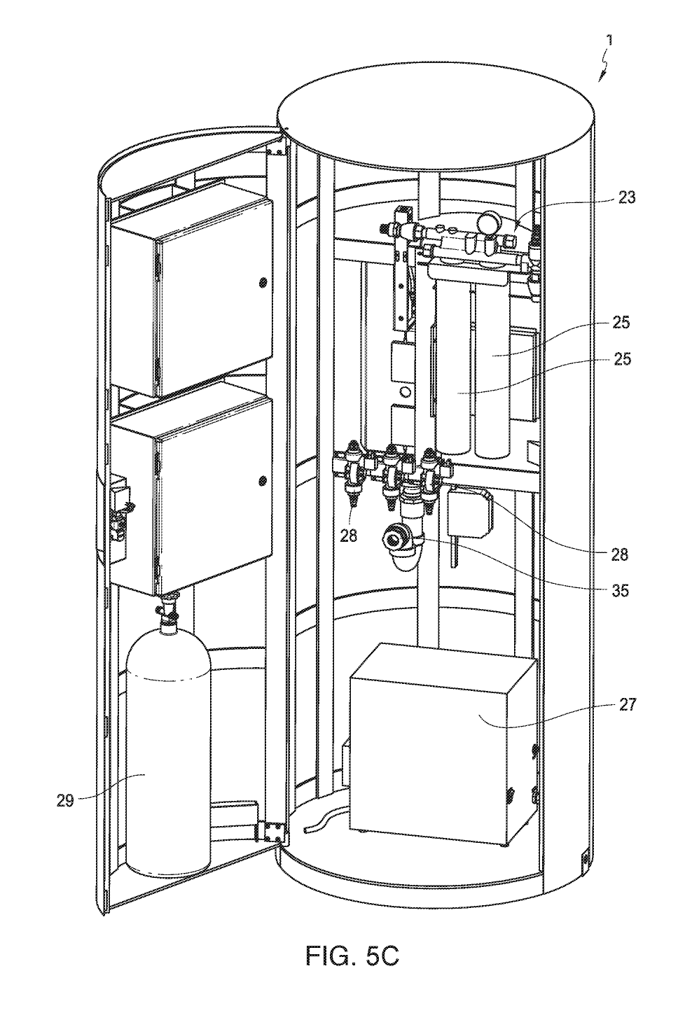

Embodiments of the invention surround a beverage kiosk system. The system includes a filtered beverage kiosk 1, as shown in FIG. 1 and FIG. 5B A kiosk 1 includes a beverage dispensing area 5, a user interface 7, and a transaction terminal 8. Certain embodiments of the kiosk accept electronic payment methods. Certain embodiments include an RFID tag and an RFID reader. In certain embodiments an RFID reader comprises an RFID reader/writer which is capable of both reading an RFID tag and modifying data stored on the RFID tag. For the purposes of this application, an “RFID reader” as used herein surrounds all devices able to read the information stored upon an RFID tag including but not limited to active RFID readers, passive RFID readers, RFID reader/writers. An RFID reader 6 is proximally located to, or in some cases, within the beverage dispensing area 5. It will be appreciated that certain embodiments of the RFID reader 6 use an NFC protocol to wirelessly communicate.

Referring to FIG. 2C, in certain embodiments, a user optionally reads or writes information to an RFID tag with an RFID reader 6a integrated with a mobile device 9. In yet other embodiments, an RFID reader 6b is part of a dongle 10 connected with a mobile device 9 or personal computer. It will be appreciated that certain embodiments of the RFID tag comprises an NFC tag. A user interface 7 includes a display screen and a user-input. For example, a user interface includes a touch screen that allows a user to interact with the information on the screen, where the kiosk software receives input from and provides information to the user interface, and communicates with the kiosk CPU.

In certain embodiments, the user interface 7 provides a user with various content. The content includes, but is not limited to, videos or graphic-based content relating to how the system works, advertisements, sustainability messaging, and other notifications. In some situations, the content is pushed out to several kiosks remotely. The content may further include, for example, availability of certain beverages, pricing information, and video content. In certain embodiments, the content is synchronized with audio content output from a speaker.

Certain embodiments of the invention include a bottle or a receptacle that will interact with the contactless payment hardware and software integral to the kiosk. The RFID reader 6 receives information from a corresponding RFID tag 4, allowing for payment based upon payment options associated with the RFID tag 4. The RFID reader 6 retrieves and records information on the RFID tag 4. In certain embodiments, each RFID tag will include a unique identification (UID) number, which is associated with payment options established by the user. When an RFID tag 4 is placed within range of the RFID reader

Certain embodiments, as shown in FIG. 2A-B, comprise an RFID-enabled receptacle, although it will be appreciated that an RFID-enabled receptacle is not limited to these embodiments. As shown in FIG. 2A, certain embodiments of the invention include a receptacle 2 having an RFID tag 4 integrated or embedded within the receptacle 2. Optionally, as shown in FIG. 2B a band 3 comprises an integrated RFID tag 4. The band 3, in certain embodiments, comprises an elastomeric material such as silicone, and is wrapped around an existing bottle or receptacle 2a. It will be appreciated that a band of alternate embodiments comprises other materials, including, but not limited to, metals, plastic, and rubber while in keeping with the spirit and scope of the present inventions. It will be appreciated that a band, as referred to herein comprises a loop of material. An RFID tag of differing embodiments can be affixed to a receptacle using various methods of fixation while in keeping with the spirit and scope of the present invention. In certain embodiments, a sleeve having an integrated RFID tag is configured to fit over a bottle or receptacle, an adhesively affixed RFID tag, or an RFID tag having a clasp or snap allowing attachment. Generally, it will be appreciated that attaching an RFID tag 4 to an existing bottle or receptacle may be accomplished by a number of mechanical mechanisms known to those skilled in the art while in keeping with the scope and spirit of the present invention.

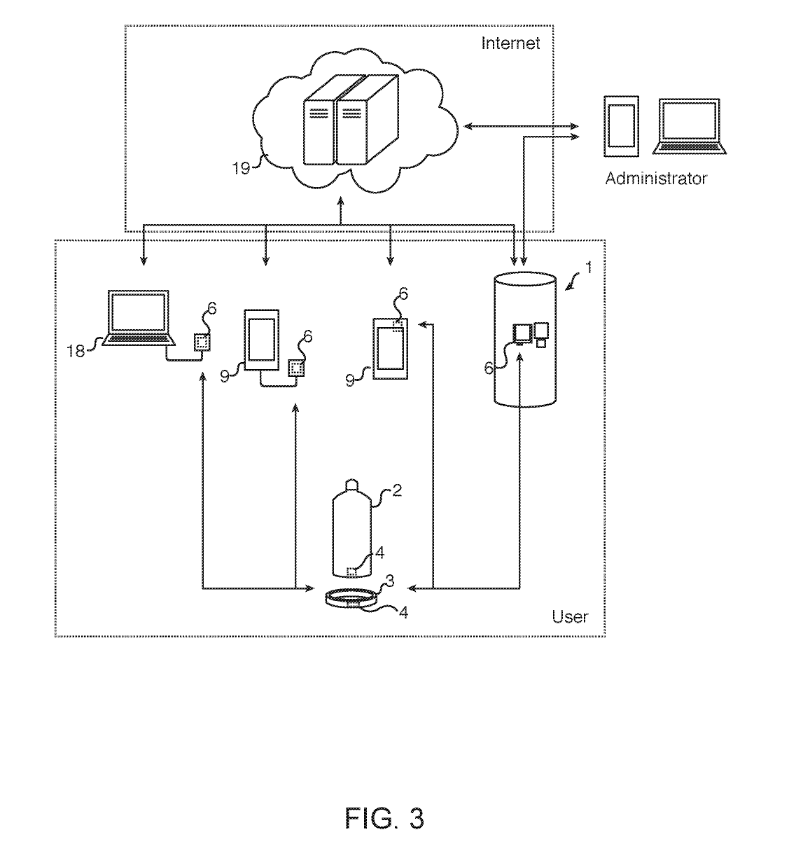

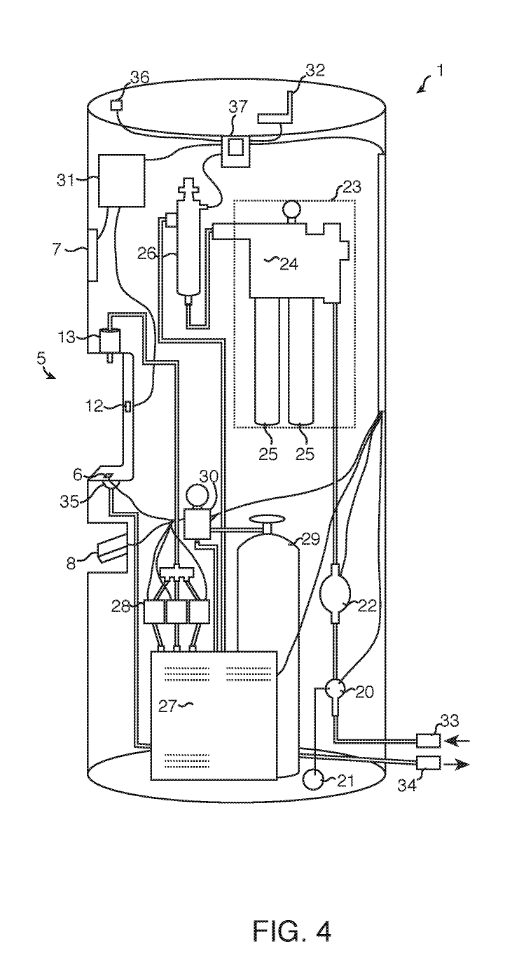

In certain embodiments, a kiosk 1 is remotely controllable by an administrator. As shown in FIG. 3, in certain embodiments, the kiosk is connected to the internet, and is further connected to an administrator's device. Through this internet connection, an administrator is able to remotely interact with the kiosk software. In certain embodiments, a kiosk includes software controlling the hardware components. Generally, a kiosk 1 has a CPU 31 connected to the hardware components (as seen in FIG. 4). The kiosk 1 optionally includes a hub 37 to facilitate this connection, although it will be appreciated that the connection occurs proximally to the CPU in certain embodiments. In certain embodiments, the hardware components are connected to the CPU 31 through a wired connection, or through a wireless connection. It will be appreciated that a wireless connection includes, for example, Bluetooth WiFi , and other wireless communication protocols. The CPU 31 executes the software to control the hardware components. In certain embodiments, the software is a firmware installed on the CPU 31. The CPU 31 is further connected to a cloud-based server 19 through, for example, a cellular modem 32. Because of the internet connection, the administrator is able to manage, control, and monitored the kiosk and the hardware components remotely.

Still referring to FIG. 3, a user (or consumer) interacts with the system through a computing device, or through the kiosk. When using the kiosk, for example, a user is able to input commands to the CPU 31 through the user interface 7, thereby controlling the amount and type of fluid to dispense.

A kiosk 1 is intended for installation in a number of areas, including, for example, universities, airports, municipalities, festivals, malls and other institutions. In certain embodiments, a kiosk uses existing plumbing infrastructure to run water through the kiosk. Referring to FIG. 4, a kiosk 1 is connected to a fluid inlet 33. It will be appreciated that the inlet 33 may be any number of sources for a fluid, for example, a municipal or commercial water supply. In certain embodiments, a kiosk 1 is connected to a fluid outlet 34, for purposes of draining—such as a waste-line. An inlet valve 20 regulates the flow of fluid into the kiosk 1. Certain embodiments of an inlet valve 20 comprise a solenoid valve connected to the CPU 31, which is further connected to the internet, allowing for remote control of the inlet valve 20. In certain embodiments, an inlet valve 20 includes, for example, an Econet® inlet valve, or other similar valves. In certain embodiments, a leak sensor 21 is coupled to the inlet valve 20, so detection of a leak in or around the kiosk 1 automatically stops the flow of fluid. A flow meter 22 records the flow of fluid through the kiosk. In certain embodiments, a flow meter 22 includes, for example, a Kampstrup® FlowIQ® 2100 ultrasonic meter, or other similar flow meter.

The water entering the kiosk 1 passes through a first filter system 23. In certain embodiments, a first filter system 23 comprises a regulator 24 and a filter 25. In certain embodiments, a filter 25 is certified under NSF/ANSI Standard 42 and 53. In certain embodiments, a filter 25 is a carbon filter. In certain embodiments, a filter 25 includes, for example, a Pentair® Everpure® 7FC-L, or other similar filters. In certain embodiments, a filter includes an adsorption filter. Following the first filter system 23, the fluid is further passed through a UV system 26 to disinfect the fluid. In certain embodiments, a UV system 26 includes an auto shut-off system having solenoid valves. The auto shut-off system detects and monitors the integrity and efficacy of the UV light, and stops the flow of fluid, and thereby ceases all dispensing operations, when UV light does not meet performance criteria. In certain embodiments, if the UV light does not meet predetermined performance criteria, this means the efficacy of the UV light at disinfecting the water entering the kiosk does not meet safety standards. Thus, those that drink the dispensed fluid may be prone to bacteria and other food-borne pathogens. Thus, the auto shut-off system actuates a solenoid operated valve to cease all fluid flow through the UV light and thereby shuts off all dispensing operations of the kiosk. In certain embodiments, a UV system 26 includes, for example, a Luminor™ Blackcomb™ LB-021A or other similar system.

Still referring to FIG. 4, in certain embodiments, a line carrying filtered and disinfected fluid is directly attached to a valve 28, which is further connected to a nozzle 13. Certain embodiments of the kiosk 1 further include a fluid chiller 27, where the temperature of the filtered and disinfected fluid is optionally lowered. In certain embodiments, a fluid chiller 27 includes, for example, a Cosmetal® J Class 30WG water chiller, or other similar fluid chiller. This chilled fluid is then connected to a valve 28, leading to a nozzle 13. Certain embodiments of the kiosk 1 include a gas tank 29, such as a CO₂ tank, attached to a regulator 30 and further connected to the filtered and disinfected fluid. The CO₂ provides carbonation to the filtered and disinfected fluid, which is regulated by a valve 28 and connected to nozzle 13. In certain embodiments, the amount of CO₂ remaining is accounted for by measuring the flow amount of the carbonated fluid through its designated valve 28. In certain embodiments, the amount of CO₂ remaining is measured through the pressure available through the regulator 30. The CPU 31 notifies the administrator or the user if the amount of remaining CO₂ is low. In certain embodiments, a valve 28 comprises an electrically actuated valve, while in certain embodiments the valve 28 further comprises a solenoid valve. In certain embodiments, a valve as described herein includes, for example, an Asco™ Series 212 Valve, or other similar valves. In certain embodiments, multiple valves 28 are used to control the flow of a plurality of different fluids. The different fluids include, but are not limited to, still water, carbonated water, and flavored carbonated water. In such embodiments, when a user selects a particular fluid for dispensing through the user interface, the CPU controls the configuration of the open or close status of the valves 28 to dispense the desired fluid. It will be appreciated that certain hardware components include a thermometer to detect the temperature of the beverage or the ambient temperature inside the kiosk. In certain embodiments, the thermometer is connected with the CPU 31 thereby allowing for further monitoring of the status of the system and fluids dispensed.

Once the fluid is filtered, disinfected, and carbonated or chilled, the fluid is ready to be dispensed to a user. In certain embodiments, a dispensing area 5 has a nozzle 13, a presence sensor 12, and an RFID reader 6. In certain embodiments, a presence sensor is an ultrasonic sensor that detects an object placed within a dispensing area 5, for example, when a receptacle is placed on a filling platform. The RFID reader 6 further reads the information from an RFID tag, if available. Additionally, a user interacts with a transaction terminal 8 if the user needs to pay for the beverage. Excess fluid is drained through the drain 35, and exits the kiosk through the outlet 34.

In certain embodiments, a kiosk further comprises a rotatable platform 100 upon which the kiosk sits. A rotatable platform 100 allows an administrator to rotatively orient the kiosk to allow for maintenance operations. Thus, a kiosk can be placed in a corner, or against a wall, while still allowing an administrator to access all aspects of the kiosk without requiring sliding or moving the kiosk in a manner that requires multiple personnel or additional machinery.

There are a number of ways in which the administrator controls the kiosk 1. In certain embodiments, the administrator is able to check the status of the kiosk and the hardware components. If there is an error or malfunction in the hardware components, the administrator is notified, which allows the administrator to fix or maintain the kiosk. In certain embodiments, an administrator has direct control of the software and hardware components, allowing the administrator to remotely turn on/off or otherwise control the kiosk. For example, an administrator turns on certain solenoid valves to flush and clean the kiosk. Alternatively, if a user is experiencing trouble with their RFID-enabled receptacle, the user can contact the administrator (for example, a customer service agent). The customer service agent can then remotely control and dispense the desired type and amount of fluid for the customer. In certain embodiments, an administrator can alter the temperature of the fluid exiting the fluid chiller 27. It will be appreciated that an administrator may administer more than one kiosk at a time.

In certain embodiments, the system price adjustments to the unit price of the fluid in real time. These price adjustments are made in response to business and environmental conditions, including, for example, the kiosk location, the time of date, events, among other variables that the administrator sets for the unit price of the fluid. In certain embodiments, the unit price of the beverage may increase, or have increased pricing based on demand. For example, increased pricing may be set to occur during a specific date, time, and location (e.g. during a music festival). Increased pricing may also be set when the number of users of the kiosk is increased.

Certain embodiments of the kiosk 1 have a thermometer 36 to detect the ambient temperature (as shown in FIG. 4). In certain embodiments, the administrator enters temperature parameters corresponding with specific prices, allowing the software to automatically adjust the unit price of the fluid based on the temperature detected.

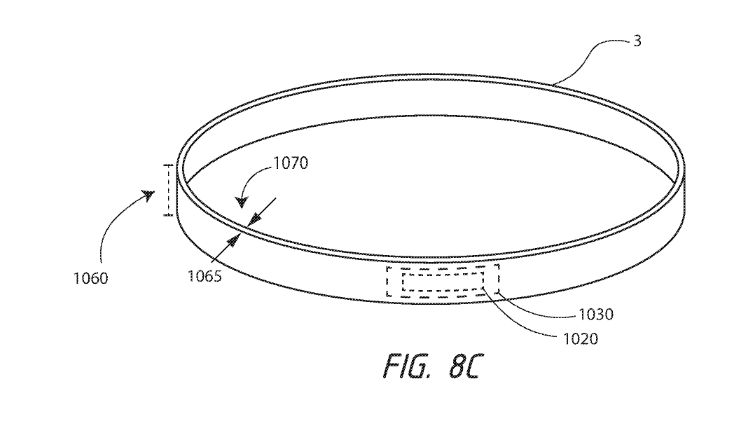

In certain embodiments, an RFID tag 1020 is embedded within a sidewall 1010 of a boot 1000, shown in FIG. 8A-FIG. 8B. A boot 1000, as referred to herein comprises a hollow geometric form, typically a cylinder, having an open first end 1001 and a closed second end 1002. The boot 1000 is configured to receive a portion of a receptacle wherein the boot 1000 is removably and slidably affixed to the receptacle. The boot 1000 of certain embodiments comprises an elastomeric material, and an RFID tag 1020 embedded within a sidewall 1010 of the boot. Furthermore, certain embodiments comprise a ferrite layer 1030 disposed between the RFID tag 1020 and an internal aspect 1040 of the boot. In certain embodiments, a boot 1000 comprises a pressure relief hole 1050 in the bottom surface 1055 of the boot. In certain embodiments, as shown in FIG. 8A, an RFID tag 1020 is embedded in the sidewall 1010 of a boot 1000 in a vertical orientation. Although the ferrite layer of certain embodiments is demonstrated as a rectangular shape, it will be appreciated that alternate geometric shapes can be used for the ferrite layer including a circular or oblong form. In certain embodiments, the ferrite layer comprises a flexible structure such that it flexes with substrate within which it is embedded.

In certain embodiments, shown in FIG. 8C, a band 3 comprises a height 1060 and a thickness 1065, wherein the thickness 1065 of the band is less than the height 1060 of the band. In certain embodiments a band, comprising an elastomeric material, comprises an RFID tag 1020 embedded within the band 3. Certain embodiments further comprise a ferrite layer 1030 disposed between the RFID tag 1020 and an internal aspect 1070 of the band.

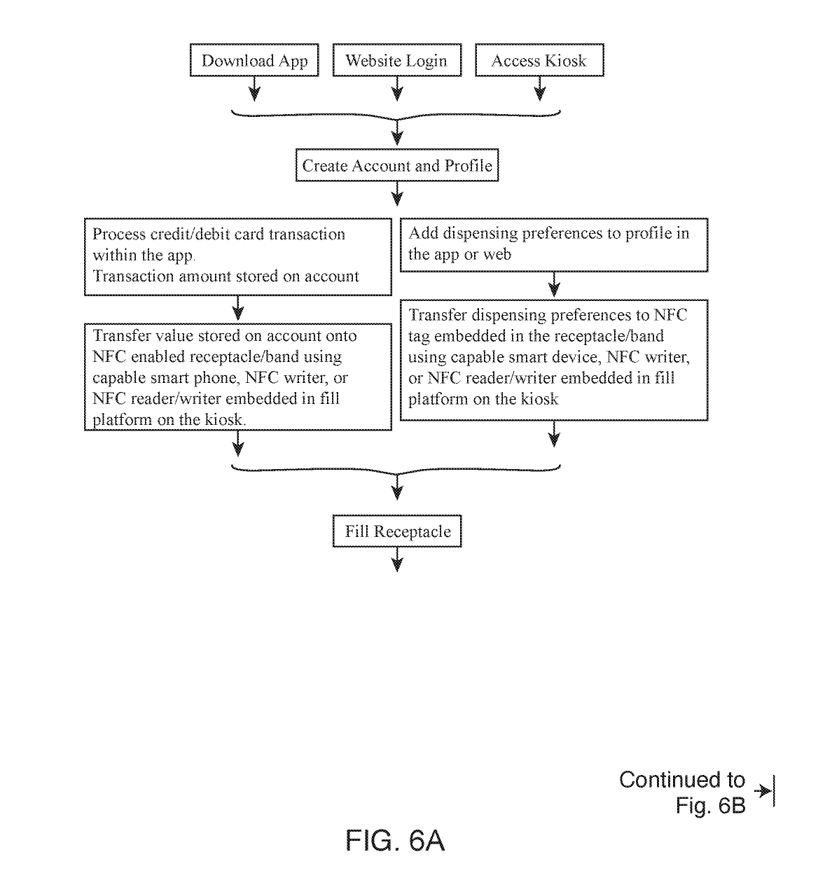

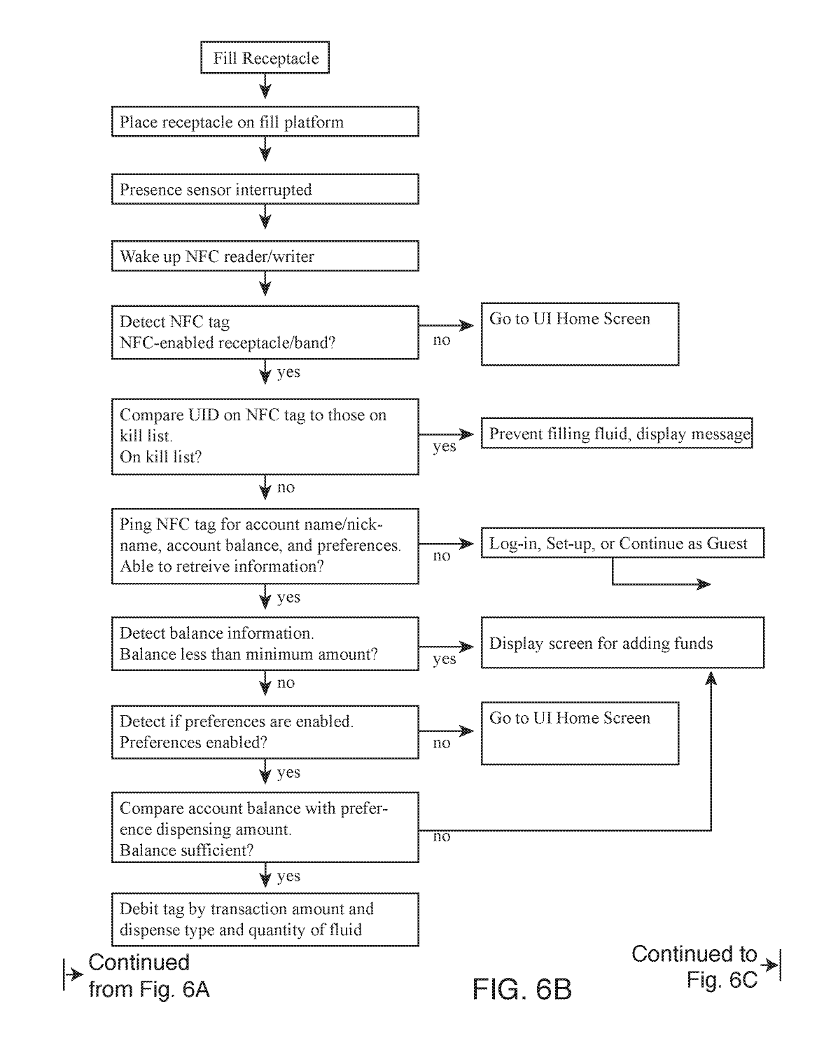

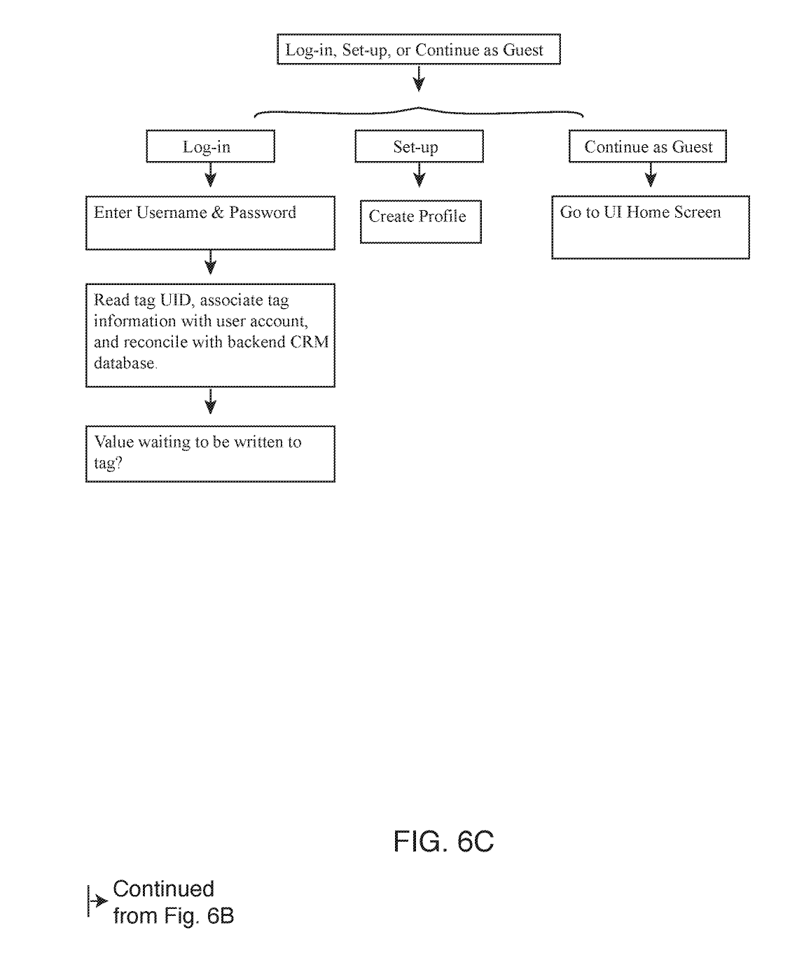

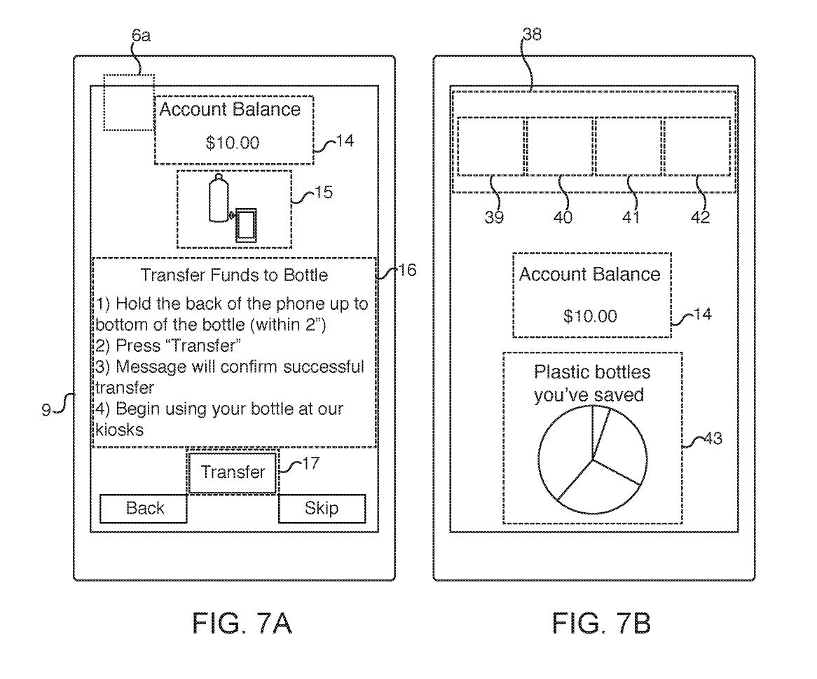

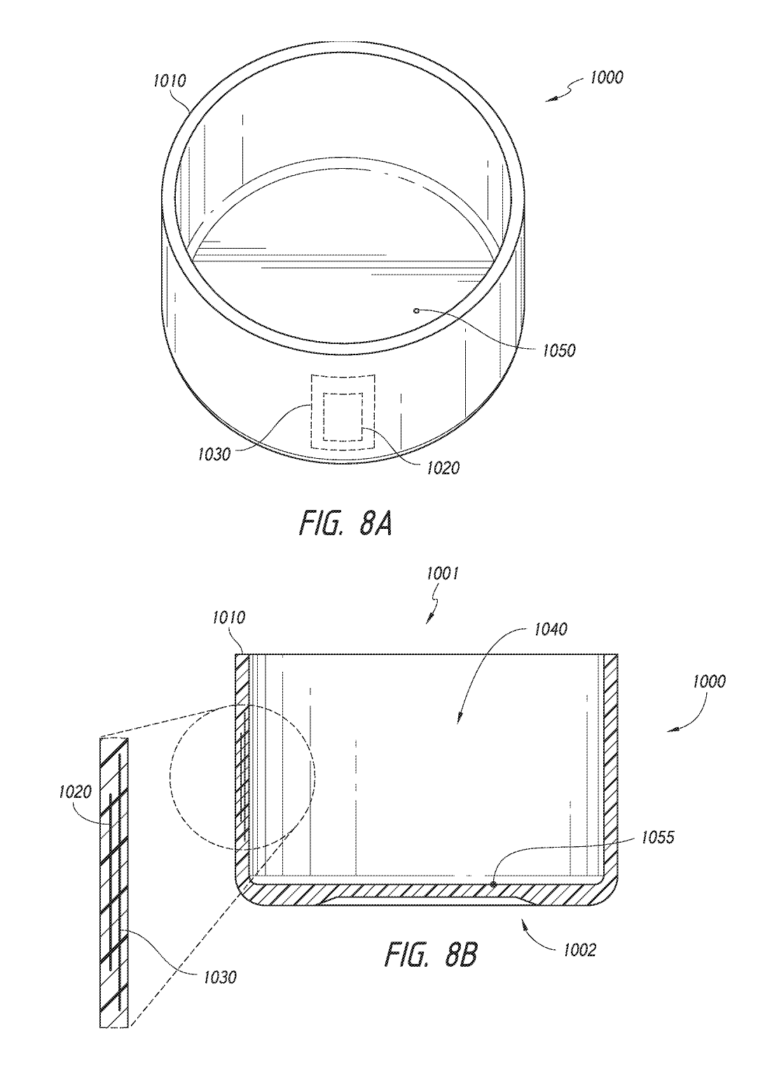

The process for a user to interact with the kiosk system can be seen, for example, in FIGS. 6A-6C. Certain embodiments of the invention further include an application that is executable on a user's computing device. In certain embodiments, versions of an application are provided for use and access with a variety of devices. Referring to FIG. 6A, a number of options are available for a user to access the application. It will be appreciated by those skilled in the art that an application refers to executable software for a computing device (such as a laptop, personal computer, and mobile phone). In one example, a user may download the application to their computing device. It will also be appreciated that the user interfaces with the database through software running on, or a website loaded on a web browser. It will also be appreciated that a user can interact directly to access the kiosk as shown in FIG. 6C, for example, through the user interface 7 as shown in FIG. 1. In certain embodiments, the kiosk has designated software that is connected to the internet and to a backend database. In certain embodiments, the kiosk software is linked with the hardware components within the kiosk, allowing a user or administrator to control these hardware components.

Referring to FIG. 3, in one example, a computing device, such as a personal computer 18 and a mobile device 9, as well as the kiosk 1 includes an RFID reader 9. The RFID reader is able to retrieve or record data onto the RFID tag 4, which may be found embedded in a receptacle 2, or on a band 3. The computing devices and kiosk 1 are further connected to a cloud-based server 19. The application, and software on the kiosk communicate with the server 19 and records the data into computer data storage, for example, into a database stored on a server. Communication with the server is accomplished through connection with the internet, for example, through Wi-Fi, cellular, Ethernet, and optical connectivity. It will be appreciated that a computer data storage includes but is not limited to, for example, a database stored on a remote server, a database stored on a storage drive in a kiosk, a user-end local storage drive, RAM, a file, and files on a server.

Referring to FIG. 6A, in certain embodiments, the customer creates an account through the application. In certain embodiments, the application is connected to computer data storage. Information input into the application communicates and stores information to the computer data storage. Once an account is created, a profile associated with the account is uploaded to the database, which is editable by the user. Information that includes, but is not limited to, first and last name, email address (username), password, nickname, and physical zip code can be entered through the application in association with the profile. The application further detects and recognizes the device that the application is being executed or accessed. In certain embodiments, the application detects if the device has an RFID reader. Once recognized, the application tailors the set-up to the specific type of device. The application optionally displays a video or text tutorial on how to use the system.

In certain embodiments, the application prompts the user to add money to the account using a debit or credit card (or other forms of electronic payment forms, and online and mobile payment systems). In certain embodiments, the application includes a payment processing gateway. Certain embodiments of a payment processing gateway includes a PCI-compliant gateway. Using such gateway, the user processes the credit or debit card transaction. In certain embodiments, the application retrieves the processed payment displays the transaction amount in discrete monetary amounts (e.g. $5, $10, $20). The user approves the transaction, allowing money to be stored within the account. Once the transaction is complete, the user receives a confirmation indicating the amount of money available in the account.

In certain embodiments, the monetary amount is converted to a stored value amount. The application converts and accounts for the stored value amount relative to the monetary amount.

In certain embodiments, the stored value amount is written onto the RFID tag 4 of the receptacle 2 or band 3.

If the user's device has an RFID reader 6a that is configured to write to the RFID tag 4, then the user can utilize such device to transfer the stored value (and additional information from the account profile) onto the RFID tag 4. The RFID tag 4 is placed in close proximity to the device's RFID reader 6a, and the stored value amount is wirelessly transferred to the embedded RFID tag 4. The RFID tag 4 then acts as a “wallet” or “purse” on which the stored value is saved.

Although certain devices include an RFID reader, certain device manufacturers have a closed architecture that does not allow data writing using the device's RFID infrastructure. In the case that a native RFID reader is not available or accessible to the computing device, the user uses a portable RFID reader 6b. In certain embodiments, a portable RFID reader 6b is connected to the computing device via an existing device port (e.g. USB, Lightning Port). Again, the RFID tag 4 is placed in proximity to the portable RFID reader 6b, and the stored value (and additional information from the account profile) is transferred to the RFID tag 4.

In one example, the user transfers the stored value amount through the application executed on a computing device, such as a mobile device 9. It will be appreciated that in certain embodiments, the user transfers the stored value amount through a website, and optionally through the kiosk user interface 7. Referring to FIG. 6A an application displays the available funds 14 on the screen. The application also displays visual instruction 15 and written instruction 16 to assist users. In certain embodiments, a virtual button 17 executes a script or program to perform certain functions. In one example as shown in FIG. 6A, a user follows the instructions 15, 16 in placing the mobile device 9 (in this example, containing an RFID reader 6a) in proximity of an RFID-enabled receptacle. Pressing the virtual button 17 activates the RFID reader to transfer data to the RFID tag. In certain embodiments, the application includes audio cues to assist in instructing how to use the system. In certain embodiments, when funds are transferred to the RFID tag, an audible chime alerts the user of the transfer.

The stored value amount is also loadable onto an RFID tag through the beverage kiosk. In certain embodiments, if an RFID reader is not available on a user's computing device, the application prompts a user to bring the RFID tag to a beverage kiosk. In one example, a user places the receptacle 2 or band 3 containing the RFID tag 4 on the RFID reader 6 on the filling platform 11. If the embedded software recognizes that the RFID tag is not associated with an account, the user interface 7 prompts the user if they would like to set up a new account, or link the RFID tag 4 to an existing account. If the user has already created an account using the application, the user accesses their account through certain log-in credentials (e.g. username and password). The kiosk software pulls the account information from the backend computer data storage, determines the stored value available to the user, and display the stored value on the user interface. The user interface 7 will display and prompt the user to transfer the stored value to the RFID tag 4. If the user selects “yes,” the RFID reader 6 writes the stored value amount from the client's account onto the embedded RFID tag 4.

Still referring to FIG. 6A, in certain embodiments, additional information can be entered into the user's account, such as adding user preferences. This additional information includes, for example, a user's name (or nickname), and user preferences. In certain embodiments, the user preferences include the type and quantity of fluid that the user prefers. The type of beverage includes, for example, ambient-temperature water, chilled water, or sparking water. In certain embodiments, this additional information is transferred into the user's account profile and associated with the unique identifier number (UID) of the RFID, In certain embodiments, this information is transferred directly to the RFID tag associated with the user's account when an RFID tag is read by an RFID reader, this additional information is transferred to the customer's account and associated with the tag's UID. The tag's UID is stored under the customer's account. This additional information is then written on the RFID tag 4 of the receptacle 2 or band 3 through the RFID reader. In certain embodiments, the additional information comprises the type of beverage (e.g. still water, carbonated water, flavored water, etc), and the preferred volume of beverage to be dispensed. In such embodiments, the kiosk will dispense the preferred type of beverage and volume of beverage as reflected by the additional information, thereby precluding the need for the user to select options via the user interface 7. Once the RFID tag 4 contains the stored value amount, the user dispenses a beverage through the kiosk.

Referring to FIG. 5B and FIG. 1, a user initiates beverage dispensing by placing an RFID-enabled receptacle in the dispensing area 5, for example, on a filling platform 11. In certain embodiments, a dispensing area 5 has a presence sensor 12 that detects the presence of an object. Once the presence of an object is detected, other components such as the user interface 7 and the RFID reader 6 are activated.

In certain embodiments, the RFID reader 6 communicates and reads information from the RFID tag 4. The kiosk user interface 7 displays the user's name (or nickname), and the stored value amount. If user preferences are stored on the RFID tag, the user interface displays an option to select automatic dispensing. In certain embodiments automatic dispensing allows a user to dispense the beverage while skipping certain steps of choosing the type and quantity of beverage to dispense. If a user chooses automatic dispensing, the RFID reader will ping the RFID tag, and confirm there is sufficient stored value on the RFID tag for the preselected quantity of beverage. If the stored value on the RFID tag is sufficient, the presence sensor confirms the presence of the receptacle prior to dispensing the beverage. Once the presence of the receptacle is confirmed, the kiosk performs the transaction and dispenses the beverage from a nozzle 13. In certain embodiments comprising automatic dispensing, the kiosk prompts the user to provide input through the user interface 7 within a predetermined period of time. In certain embodiments the predetermined period of time is 2 seconds. A predetermined period of time of alternative embodiment comprises less than or more than 2 seconds while in keeping in the spirit and scope of the present invention. The kiosk software debits the stored value on the RFID tag by the amount of the transaction. The kiosk software also captures other information pertaining to the transaction, including the time, date, type of beverage, quantity of beverage, kiosk location, and value of the transaction. This captured information is further associated with the user account, and stored into a backend database, for example, a customer relationship management (CRM) database. The captured information is sent to the backend database stored on a data server through, for example, Wi-Fi, cellular, Ethernet, optical, or other communication protocols.

In certain embodiments, the kiosk contains electronically controlled valves (e.g. solenoid valves) to open and dispense certain types of fluids, including for example, ambient-temperature water, chilled water, or sparking water. The electronically controlled valves further regulate the amount of time the valves are open as to dispense the selected quantity.

If a user does not choose automatic dispensing, the user interface displays prompts for alternative ways to dispense a beverage. In certain embodiments, these alternative options include, for example, the type and quantity of beverage. By selecting the prompts on the user interface, the user is able to choose the type of fluid to dispense, for example, ambient-temperature water, chilled water, or sparking water. The user is also able to choose the quantity of the beverage. The kiosk software confirms there is sufficient stored value amount on the RFID tag for the preselected type and quantity of beverage. In certain embodiments, a stored value amount unit is converted to the type and quantity of a beverage. For example, one stored value amount corresponds to a certain volume of a certain beverage type. An administrator may optionally change the conversion rate of a stored value amount unit to a beverage type and quantity. In certain embodiments, this conversion rate is changed based on the kiosk's location, the time of date, events, among other variables. The kiosk software retrieves the conversion rates, and compares the available stored value amount on the RFID tag for the preselected type and quantity of beverage. If the available stored value amount on the RFID tag is sufficient, the kiosk software opens the appropriate valve for the prescribed amount of time to dispense the beverage.

Once the type and quantity of the beverage is selected, in certain embodiments, the presence sensor confirms the presence of the receptacle prior to dispensing the beverage. The beverage is dispensed. The kiosk software debits the stored value amount on the RFID tag by the amount of the transaction. Again, the kiosk software captures other information pertaining to the transaction, including the time, date, type of beverage, quantity of beverage, kiosk location, and value of the transaction. This captured information is further associated with the user account, and stored into a backend CRM database.

In certain embodiments, the kiosk includes a manual fill option. Under a manual-fill option, the user is also able to control the quantity of fluid to dispense through the user interface. The user interface optionally displays a press-and-release virtual button, which allows a user to begin and end the flow of the beverage. If the customer chooses the manual fill option, the kiosk software communicates with the RFID reader 6 to retrieve the amount of stored value on the RFID tag. The kiosk software then sets the maximum dispensable quantity that is allowed based on the stored value. The kiosk software debits the stored value on the RFID tag by the amount of the transaction. Again, the kiosk software captures other information pertaining to the transaction, including the time, date, type of beverage, quantity of beverage, kiosk location, and value of the transaction. This captured information is further associated with the user account, and stored into a backend CRM database.

In certain embodiments, the kiosk software allows dispensing a beverage quantity of up to a certain maximum volume. Once the transaction is complete, the user interface displays a message and re-sets the kiosk for use by a subsequent user.

In certain embodiments, if the stored value on the RFID tag is insufficient, the user interface prompts the user to add value through the kiosk. Users add value to their account by interacting with the user interface 7 and the transaction terminal 8. It will be appreciated that a variety of transaction methods are available, and the transaction terminal 8 includes transaction interfaces (e.g. magnetic strip reader, chip reader) for receiving payment through these transaction methods. Examples of transaction methods include, for example, credit or debit card, chip-based cards, contactless payment protocols including EuroPay®, MasterCard®, and Visa® (EMV) protocols such as Apple® Pay, and NFC payment protocols such as ISO/IEC 14443. In one example, a user adds stored value to the RFID tag 4 by processing a debit or credit card through the transaction terminal 8. The user is prompted to select the amount of funds to transfer to the account, and further prompted to insert or swipe a debit or credit card. When the payment transaction is complete, the kiosk software converts the transaction amount into a stored value. The kiosk software communicates with the RFID reader to write the stored value onto the RFID tag. If successful, the user interface displays a message indicating that the transaction completed and the value transferred to the RFID tag, and further displaying the new balance on the RFID tag.

In certain cases, a user does not have an RFID-enabled receptacle. For these users, the kiosk user interface displays an open-loop payment option to purchase a beverage through the transaction terminal 8. In certain embodiments, the customer places a beverage container on the filling platform, and selects the type of beverage through the user interface. The user interface prompts a user to make a selection on the mode of dispensing the beverage, including one-touch dispensing, and manual fill. If the user chooses one-touch dispensing, a user is able to pre-select the quantity of the beverage to dispense. The user interface then prompts a user to make a payment through the transaction terminal 8. The kiosk software deducts the funds corresponding to the quantity and type of beverage ordered, and dispenses the order.

If the user chooses manual fill, the user controls the quantity of fluid to dispense through the user interface. The user interface prompts a user to make a payment through the transaction terminal 8. The user interface optionally displays a press-and-release virtual button, allowing the user to dispense the fluid. If the fluid is not dispensed for a certain period of time, the software measures the quantity and type of fluid dispensed and further charges the payment.

In certain embodiments, users can report a lost or stolen RFID-enabled receptacle or band. Reporting a loss of the RFID tag prevents a third-party from using the RFID tag. In certain embodiments, the UID of the RFID tag contains information on whether the RFID tag was part of a receptacle or band, the date in which the RFID tag was activated, and information regarding the amount and the time that the stored value was added. The information on the UID will allow further identification of the RFID tag. Once a particular RFID tag has been confirmed lost or stolen, the UID of the tag is added to a “kill list” in the CRM database. Kiosks will not be able to dispense a beverage if the particular RFID-enabled receptacle is used. If its use is attempted, the kiosk software captures the time, date, and kiosk location in which the lost or stolen RFID-enabled receptacle is used. If recovered, the owner of the particular RFID-enabled receptacle can remove the UID from the “kill list.”

In certain embodiments, users can report problems with a kiosk through the user interface. In certain embodiments, a user selects a menu to report a problem, and chooses from a list of common problems. Users can also type their own response. The kiosk software will record the reported problem, determine the serial number of the kiosk for which the problem was reported, and transmit that data to the kiosk administrator.

In certain embodiments, the system tracks data relating to a user's utilization of the kiosk, and application. In some cases, these data are displayed to the user as to reinforce positive behaviors, such as positive environmental impact and cost savings. As shown in FIG. 7B, certain embodiments of the app include a menu 38 with selectable buttons 39, 40, 41, 42 that link the user to certain features. Examples of features accessible through the application include, but are not limited to, history of kiosk usage, the ability to add funds through the application, the location of the kiosks, and notifications. In certain embodiments, the application outputs a report 43 detailing, for example, the user's water consumption, and the amount of plastic waste saved.

Example: The following is an exemplary process in which a user purchases a beverage from a kiosk.

Step 1—User purchases a receptacle that has an embedded RFID tag manufactured into the base of the bottle. If the user prefers to use their own bottle or receptacle, they can obtain a silicone band with an embedded RFID tag that they can place around their own bottle.

Step 2—User downloads the application found in certain embodiments, and sets up an account.

Step 3—Using a debit or credit card, (or other forms of electronic payment forms, and online and mobile payment systems; e.g. Venmo, PayPal), a user processes a transaction for a specified amount inside the application. The amount of the value will be converted to a stored value amount. The stored value amount can further be transferred onto the RFID tag embedded in the bottle or silicone band.

Step 4—If the customer's smart phone has open architecture that allows for writing RFID data, the customer holds their computing device up to the embedded RFID tag (bottle or tag) and transfers the stored value amount from the application onto the RFID tag. The tag will then act as the “purse” and contain the stored value amounts to be debited when the customer dispenses fluid. If the customer's computing device does not allow the user to write data using the built-in RFID writer, the user can plug in a peripheral or portable RFID writer into the computing device and transfer the stored value using the peripheral RFID writer.

Step 5—Value can also be added at the kiosk by processing a user's payment through the transaction terminal. The user places the RFID-enabled bottle or band adjacent to the RFID reader on the filling platform, and transfers the stored value to the embedded RFID tag.

6. Users can set preferences to their account using the application (allowing automatic fill), and transfer these preferences to the RFID tag by using the RFID reader in the phone or the peripheral RFID reader.

Step 6—Users place their RFID enabled bottle or band on the filling platform at the kiosk, select the type and volume of fluid to be dispensed. Alternatively, if preferences are set to include automatic, such information is communicated from the RFID tag to the RFID reader and dispensing will happen automatically. The kiosk will debit from the stored value on the RFID tag and update the stored value amount on the RFID tag, and dispense the amount and type of fluid into the receptacle.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

1. A beverage kiosk system for dispensing a beverage comprising:
(a) a kiosk comprising:
an RFID reader/writer;
a user interface having a touch screen display, the user interface configured to receive input from a user;
a presence sensor configured to detect the presence of an object placed within a dispensing area;
a transaction terminal,
a first electrically actuated valve connected to a nozzle configured to dispense a beverage;
a CPU having connection to the RFID reader/writer, the user interface, the presence monitor, the transaction terminal, and the first electrically actuated valve;
the CPU having software configured to control the configuration of the first electrically actuated valve between an open and closed configuration to alternatively dispense and stop dispensing the beverage;
(b) an RFID tag associated with a user's account affixed to a receptacle with a ferrite layer disposed between the RFID tag and the receptacle; and
(c) an application comprising:
a payment processing gateway configured to receive payment transaction data for processing payment through the gateway,
wherein the application converts the payment transaction data to a stored value amount, records the stored value amount to a user's account, and
wherein the RFID reader/writer reads the RFID tag and writes the stored value amount to the RFID tag, and
wherein the software of the CPU compares the stored value amount on the RFID tag to value of the type and quantity of the beverage requested, and dispenses the beverage if the stored value amount is greater than or equal to the value of the type and quantity of the beverage requested.

2. The beverage kiosk system of claim 1, wherein the RFID tag is configured to be removably affixed to the receptacle.

3. The beverage kiosk system of claim 2, wherein the RFID tag is embedded in a band configured to be affixed to the receptacle.

4. The beverage kiosk of claim 3, wherein the ferrite layer is embedded in the band between the RFID and the inner aspect of the band.

5. The beverage kiosk system of claim 2, wherein the RFID tag is embedded in a boot configured to be affixed to the receptacle;
the boot comprising a hollow cylindrical form having an open first end, and a closed second end;
the RFID tag embedded within the sidewall of the hollow cylindrical form.

6. The beverage kiosk of claim 5, wherein the ferrite layer is embedded in the boot between the RFID and the inner aspect of the boot.

7. The beverage kiosk system of claim 6, wherein the kiosk further comprises a filling platform.

8. The beverage kiosk system of claim 7, wherein the presence sensor further is directed toward the filling platform,
wherein the presence sensor is configured to detect the receptacle.

9. The beverage kiosk system of claim 8, wherein the presence sensor is an ultrasonic sensor.

10. The beverage kiosk system of claim 9, wherein software of the CPU configures the first electrically actuated valve to dispense the beverage into the receptacle when the presence sensor detects the receptacle on the filling platform.

11. A device for removably affixing an RFID tag to a beverage receptacle comprising:
a hollow cylindrical form having an open first end, and a closed second end;
an RFID tag embedded within a sidewall of the hollow cylindrical form; and
a ferrite layer disposed between the RFID tag and an internal aspect of the hollow cylindrical form.

12. A method of dispensing a beverage from a beverage kiosk system, comprising the steps of:
processing a payment through a payment processing gateway on an application;
receiving payment transaction data from processing said payment;
converting the payment transaction data to a stored value amount;
writing the stored value amount to an RFID tag;
affixing the RFID to the receptacle;
reading the stored value amount, wherein reading the stored valued amount is performed by an RFID reader/writer located at a beverage kiosk;
receiving a beverage type and quantity for dispensing;
comparing the stored value amount on the RFID tag to a value of the beverage type and quantity selected; and
dispensing the beverage in accordance with the beverage type and quantity selected if the value of the beverage type and quantity selected is equal to, or less than, the stored value amount on the RFID tag.

13. The method of claim 12, wherein the RFID tag is embedded in an elastomeric band, and
wherein a ferrite layer is disposed between the RFID tag and an inner aspect of the band.

14. The method of claim 12, wherein the RFID tag is embedded in an elastomeric boot, and
wherein a ferrite layer is disposed between the RFID tag and an inner aspect of the boot.

15. The method of claim 14, further comprising a step of writing preferences to the RFID tag,
wherein the preferences comprise a preferred beverage type and a preferred quantity; and
wherein the step of receiving a beverage type and quantity for dispensing is performed by the RFID reader/writer.

16. The method of claim 15 further comprising, debiting value of the beverage type and quantity selected from the stored value amount, and updating the stored value amount.

17. The method of claim 16, further comprising placing the RFID tag in near proximity to the RFID reader/writer thereby initiating an automatic dispensing comprising the steps of reading, receiving, comparing and dispensing.
